(19) United States
(12) Patent Application Publication
(10) Pub. No.: US 2025/0264086 A1
(43) Pub. Date: Aug. 21, 2025

(54) CONNECTING DEVICE FOR A TOWER-LIKE STRUCTURE, IN PARTICULAR AN OFFSHORE WIND TURBINE, TOWER-LIKE STRUCTURE COMPRISING SUCH A CONNECTING DEVICE, AND METHOD FOR MANUFACTURING SAID STRUCTURE

(71) Applicant: ROSEN 2 Holding AG, Stans (CH)

(72) Inventors: Nils Rentmeister, Lingen (DE); Alexander Lindner, Ochtrup (DE); Hanna Kruempel, Neuenkirchen (DE)

(21) Appl. No.: 18/575,541

(22) PCT Filed: Jun. 29, 2022
(86) PCT No.: PCT/EP2022/067916

§ 371 Date: Mar. 21, 2025

(30) Foreign Application Priority Data
Jun. 29, 2021 (BE) BE2021/5507

(51) Int. Cl. F03D 13/20; E04H 12/34; F03D 13/25

(52) U.S. Cl. CPC F03D 13/206; E04H 12/342; F03D 13/204; F03D 13/25; F05B 2230/60; F05B 2240/91; F05B 2240/95; F05B 2240/97

(57) ABSTRACT

A connecting device for a tower-like structure is provided, and includes a plurality of connecting elements which are arranged between an upper component and a lower component of the structure in order to produce a slip joint, and for the purpose of load transfer between the upper component of the structure and the lower component of the structure, are to be positioned next to one another in the peripheral direction about the longitudinal axis and/or in the longitudinal direction thereof with respect to a central longitudinal axis of the structure. With respect to the longitudinal axis, the connecting device has a greater thickness in the centre thereof than at its upper and/or lower end.

### CROSS REFERENCE

This application claims priority to PCT Application No. PCT/EP2022/067916, filed Jun. 29, 2022, which itself claims priority to Belgian Patent Application No. BE2021/5507, filed Jun. 29, 2022, the entireties of both of which are hereby incorporated by reference.

### FIELD OF THE INVENTION

The present invention relates to a connecting device for a tower-like structure, and in particular an offshore wind turbine tower-like structure comprising such a connecting device. The present invention also relates to a method for manufacturing such a structure.

### BACKGROUND OF THE INVENTION

EP 3443224B1 discloses generic subject-matter. However, it has been found that, as a result of deviations of the components, which are several meters high, from the desired dimensions thereof, undesirable voltage peaks may occur, in particular at the lower end of the upper component and at the upper end of the lower component.

### BRIEF SUMMARY OF THE INVENTION

An object of the present invention is to minimize these voltage peaks.

A connection apparatus according to the invention for a tower-like structure, in particular an offshore wind turbine, comprising a plurality of in particular plate-like or layer-like connection elements which in order to produce a slip joint are intended to be arranged between an upper component and a lower component of the structure or support structure and for the purpose of the load transfer between the upper component of the structure and the lower component of the structure are intended to be positioned beside each other in a circumferential direction about the longitudinal axis and/or in the longitudinal direction thereof with respect to a longitudinal center axis of the structure, is characterized in that with respect to the longitudinal axis the connection apparatus centrally has a greater thickness than at the upper and/or lower end thereof, in particular wherein at least one central connection element which is positioned in a longitudinal direction between an upper and a lower connection element has a greater thickness than the upper and/or the lower connection element. The thickness increase leads in this region of the structure to a greater load transfer from the upper component of the structure to the lower component of the structure. The voltage peaks which are present at the ends of the respective component are thereby reduced or even avoided.

The thickness of a plate-like or layer-like connection element is in this instance the extent of the connection element in the direction perpendicular to the planar extent thereof. The thickness is generally significantly smaller than the length and the width of the connection element. Typically, there is a factor of at least 5, preferably of at least 10, between the thickness and the width and/or the length of the connection elements. Preferably, the thickness of the individual plate-like or layer-like connection elements is in a range from 1.5 to 20 cm, preferably in a range from 2 to 10 cm. The thickness is measured in the direction of a perpendicular to the surface of the connection element to the longitudinal center axis which in the mounted position of the connection apparatus typically extends from the base of the structure centrally in an upward direction. For the measurement of the thickness of the connection elements, however, these are not considered to be acted on with a load by the components of the structure.

In a state “centrally with respect to the longitudinal axis”, the connection apparatus has in particular a greater thickness when over the height of the connection apparatus which is formed, for example, by two rings of connection elements, the region between 15% and 85% of the height is constructed to be at least in places thicker than the one between 0% and 15% of the height and/or the one between 85% and 100% of the height. In this region between 15% and 85% of the height, with spacing from the upper and lower edge of the connection apparatus a greater load is transferred. Preferably, the thickness of the central region is a maximum of three times the thickness of the upper or lower region, wherein corner chamfered portions or local recesses of a connection element are not taken into account. In the case of two rings of connection elements, for example, the upper half of the lower ring and the lower half of the upper ring may be constructed to be thicker.

The plates are considered to be arranged beside each other in the longitudinal direction when they are arranged beside each other in the direction of the longitudinal axis when viewed in a direction transverse to the longitudinal axis, that is to say, are arranged above or below each other in particular perpendicular to the horizontal underlying surface. The longitudinal center axis is the longitudinal axis which extends in the assembled state of the structure vertically from the underlying surface in the middle and centrally through the structure in an upward direction.

A slip joint or slip joint connection is intended to be understood to be a connection between a lower component of the structure and a lower component of the structure in which the upper component and the lower component in each case have at least one partially conical region and these conical regions are at least partially stacked inside each other in the manner of a stack of cups. As a result of the upper portion being placed over the lower portion, a friction-based connection is produced without the use of mortar or bolts, which leads to a simplified production of these structures as a result of simplified assembly and reduced use of material.

Plate-like connection elements are in the context of the present invention ones which prior to the arrangement on one of the components of the structure are produced as portable and/or transportable plates. They can still be processed after their production before they are secured to one of the two components. In the context of the invention, layer-like connection elements are ones which are produced as a layer directly on one of the components, in particular by means of an injection-molding or casting method. Layer-like connection elements of different thicknesses can be produced by means of a plurality of sequential or also by means of a single casting or injection-molding operation(s) in which a portion of the surface is provided with more material. Accordingly, layer-like connection elements may merge integrally into each other and be characterized by different thicknesses. For the production of accordingly spatially limited, layer-like connection elements on a portion of a structure, this can first be provided with a shape or a formwork in which the material which is intended to be applied is then injected or cast. It is also conceivable for the individual components of the structure in order to produce the connection elements to be moved relative to an injection-molding or casting apparatus in order to produce an application of the desired thickness.

As a result of the preferably annular, plate-like or layer-like and in particular compressible and/or resilient connection elements, geometry deviations of the components from the desired dimension thereof are already compensated for to a small degree. As a result of the size of the components of the structure and the resultant tolerance deviations, however, no adequate tolerance compensation has been possible with conventional connection elements. According to a further development of the invention, a compensation is only achieved as a result of selective thickness adaptations of the connection elements. In particular as a result of an increased thickness of the central connection elements, however, an improved tolerance compensation with respect to a conventional connection apparatus is already achieved in this region of the connection.

In order to compensate for additional geometry deviations, that is to say, deviations of the geometry of the structure from a predetermined desired dimension, it is further advantageous for a plurality of central connection elements which are arranged beside each other between an upper and a lower connection element in a longitudinal direction to have a greater thickness than the upper and/or the lower connection element. These central connection elements may also have mutually different thicknesses so that, when viewed in a longitudinal direction, a, for example, step-like increase of the thickness in a direction toward the center of a connection region is present and the thickness then sequentially decreases again toward the upper end.

In order to compensate for geometry deviation in the circumferential direction, it is according to the invention further advantageous when, from connection elements which are arranged beside each other in a circumferential direction about a longitudinal center axis, at least one has a greater thickness than the connection elements which are arranged beside it.

It is also advantageous in another embodiment according to the invention if in a circumferential direction or longitudinal direction at least one individual element of the connection elements has a thickness which is already different. A connection element is arranged above a (another) connection element when it is arranged in the installation position of the structure with respect to a vertical longitudinal center axis thereof relative to the underlying surface above the lowest connection element.

Advantageously, the connection elements of a connection apparatus may in the assembled position be arranged spaced apart from each other between the two components of the structure. However, it is also conceivable for these connection elements to be positioned with spacing from each other, wherein the spacing can be selected in such a manner that, in the event that at least some of the connection elements are at least partially resiliently deformable, as a result of the pressing of the respective connection element, this spacing is reduced or even reduced to zero. To this end, all or also only some of the connection elements may be constructed to be at least partially resiliently deformable. In particular, it may be a layer of an annular, plate-like or layer-like connection element which is constructed in a resilient manner.

Advantageously, at least some of the connection elements are constructed to be at least partially compressible, wherein the compressibility of the respective connection element is formed in particular by means of a structuring of the surface and/or the material of at least one layer of the multi-layered connection element. A material which changes its density under pressure is considered to be compressible. For example, this applies to polyurethanes which are foamed or provided with aggregates.

Preferably, the connection elements according to the invention are at least partially made from a polyurethane. For example, the plates are constructed from one or more layers of a polyurethane having a Shore hardness A between 75 and 95, preferably between 80 and 90. These plate-like connection elements can be adhesively bonded using a resilient adhesive on a steel surface of the lower and/or the upper component, in particular of the monopile or the transition piece.

In particular, the connection elements are at least predominantly and preferably at least up to a proportion of 95% made from polyurethane (PU).

The connection apparatuses according to the invention may have connection elements which are constructed with at least two layers and which, in addition to at least one layer of polyurethane or a plastics material which acts in the same manner with regard to durability, hardness and compressibility and expandability, have an additional layer. In particular, in addition to the resiliently deformable and/or compressible polyurethane layer at least some of the connection elements may additionally have a layer of an anti-friction paint. This layer may cover the polyurethane layer or the layer comprising the additional plastics material partially or also completely circumferentially.

Advantageously, at least some of the connection elements may have a thickness which decreases in the direction of the longitudinal axis so that they are constructed in cross section, for example, to taper at least partially in a wedge-like manner. For example, at least one of the connection elements may have a chamfered edge. As a result of a chamfering of individual connection elements, the placement of the components of the structure one in the other can be simplified, in particular the connection elements which are mounted on the lower structure have a smaller thickness at the upper end thereof. Alternatively or additionally, connection elements which are mounted at the side of the upper component, that is to say, the one which has to be fitted over, may have a smaller thickness at the lower end thereof.

Alternatively or additionally, at least some of the connection elements may be provided at least partially with an adhesive layer which facilitates the assembly on a component of the structure.

In particular, at least some of the connection elements, at a minimum one connection element, has at least one friction-reducing coating, in particular a layer of an anti-friction paint, which simplifies the fitting of the components into each other and consequently also ensures a more uniform load transfer. The friction-reducing coating may completely circumferentially enclose the polyurethane layer. There may in this case also be two layers which are arranged on surfaces of the polyurethane facing away from each other.

The assembly and the operation of the structure are improved if, according to another exemplary embodiment according to the invention, at least two of the connection elements have mutually complementary, in particular positive-locking connection regions. These may, for example, in this instance be tongue and groove connections or also projections and recesses which engage in each other, for example, in the manner of a scarf joint.

Advantageously, a connection element has at least one recess which is preferably introduced after the production thereof in order to receive a portion of a component. For example, it may in this instance be a groove which is subsequently milled in order to receive a weld seam.

The object set out in the introduction is also achieved by a tower-like structure of a wind turbine which is in particular in the form of an offshore structure and which comprises at least one lower component which is in particular in the form of a monopile and at least one upper component which is in particular in the form of a transition piece and which in order to form a slip joint is partially placed over the lower component, wherein between the upper component and the lower component a connection apparatus described above or below is arranged. This structure has the advantages which are explained accordingly.

The object set out in the introduction is also further achieved with a method for producing a tower-like structure as described above which is characterized in that at least some of the connection elements are injection-molded or cast on the lower component and/or the upper component.

The object set out in the introduction is further achieved in that at least some of the connection elements are produced beforehand and subsequently secured to the lower component and/or upper component. In particular to this end, the upper and/or lower component is measured after the production thereof, whereby a deviation measurement which results from a deviation from a desired shape can be determined. This deviation measurement is then taken into account by the different thickness and/or planar extent of the connection elements. This consideration is carried out either already during the production of the respective connection element, for example, by adapting the cast shape or the casting operation. Alternatively or additionally, the deviation measurement may also be taken into consideration by re-processing the connection elements or the connection element. This is particularly advantageous in that larger quantities of connection elements can be preproduced in order to then subsequently adapt them where applicable in situ and further to adapt them during the installation with regard to their thickness and extent.

For the installation, it is advantageous to keep the connection elements at the desired position, for example by means of a magnetic holder, until any adhesive has cured.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1: shows a wind turbine having a tower-like structure according to the invention.

FIG. 2: shows a vertical section through a portion of the object according to FIG. 1.

FIG. 3: shows a section through a portion of an object according to the invention in an arrangement on a transition piece.

FIG. 4: shows a partial view of another apparatus according to the invention.

FIG. 5: shows examples of connections of the connection elements of an object according to the invention.

FIG. 6: shows a partial view of another object according to the invention.

### DETAILED DESCRIPTION OF THE DRAWINGS

The features of the exemplary embodiments according to the invention as explained below may also individually or in combinations other than those set out or described be the subject-matter of the invention, but always at least in combination with the features of one of the independent claims. As long as it is advantageous, components which have the same function are given identical reference numerals.

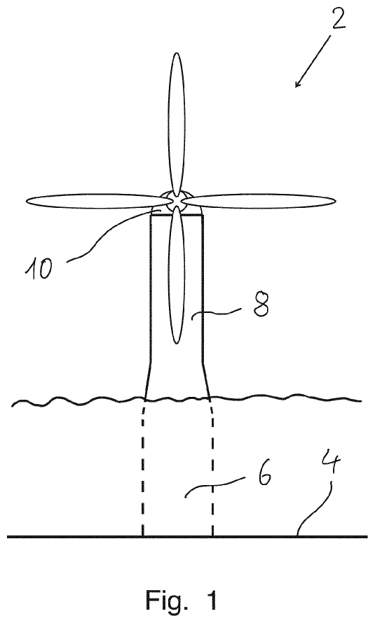

According to FIG. 1, an offshore wind turbine 2 has a lower component 6, which is positioned on a sea bed 4, of a structure according to the invention. This component 6 is in this instance in the form of a so-called monopile. However, it may also be a construction of a tripod foundation which is formed with a plurality of posts. The posts thereof are then connected by means of individual slip joint connections to respective upper components 8 which are placed over corresponding lower components 6. The components 6 and 8 represent with a connection apparatus according to the invention a structure which is also in accordance with the invention. In place of an offshore installation, such a wind turbine can also be installed onshore.

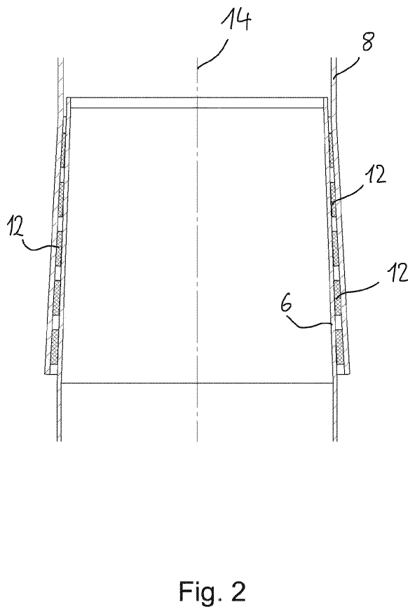

There is positioned between the two components 6 and 8 a connection apparatus 10 according to the invention which is illustrated in greater detail in FIG. 2. The connection apparatus is located in a connection region between the conical portions of the lower component 6 and the upper component 8. Whilst the connection apparatus in the exemplary embodiment according to FIG. 2 does not have directly adjoining connection elements 12, it may also be formed from individual connection elements 12 which are arranged in a circumferential direction about a longitudinal axis 14 of the structure and which are arranged along it without spacing from each other. In order to compensate for different cone angles, the lower connection elements 12 are thicker than the upper connection elements 12.

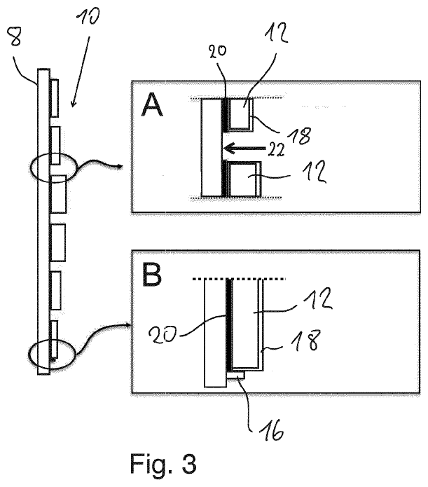

The connection elements 12 according to FIG. 3 are illustrated in a section in a state arranged on a transition piece, the upper component 8. Only one side of the vertical longitudinal section is shown, in this instance the left side. The connection elements 12 according to FIG. 3 also have different thicknesses, wherein the central four connection elements 12 with respect to the height have a greater thickness than the lowest and the uppermost connection element 12. From this total of four central connection elements 12, the two centrally arranged connection elements 12 again have a greater thickness than the connection elements 12 which are arranged above and below relative thereto so that from the bottom in an upward direction a step-like path with connection elements 12 which are initially thicker and which then become thinner is produced. The load transfer with conical components with the same cone angles is carried out relatively mainly by the thicker elements and consequently in a central region between a lower end of the upper component 8 and an upper end of the lower component 6, with respect to the longitudinal axis 14 of a structure.

The lowest connection element 12 is limited at the lower end thereof by a support 16 (detailed view B of FIG. 3) which represents a structural positive-locking connection with the surface of the upper component 8. The horizontal extent of this support 16 is advantageously smaller than the thickness of the lowest connection element 12, whereby a sliding thereof and of the connection elements which are located above is prevented. At the same time, the horizontal extent according to the illustration in FIG. 3 in the section illustrated at that location is not so large that the support 16 in the mounted position of the structure touches the lower component 6. Alternatively, in the arrangement of connection elements 12 on the lower component 6, a corresponding support may also be arranged at that location.

The connection elements 12 are completely circumferentially provided with a friction-reducing coating 18 in the form of an anti-friction paint and secured by means of an adhesive layer 20 to a surface 22 of the upper connection element 8 (detailed views A and B of FIG. 3). The thickness of the coating 18 is small in comparison with the thickness of the respective connection element 12, in particular the thickness of the coating 18 is no more than 5% of the thickness of the connection element 12.

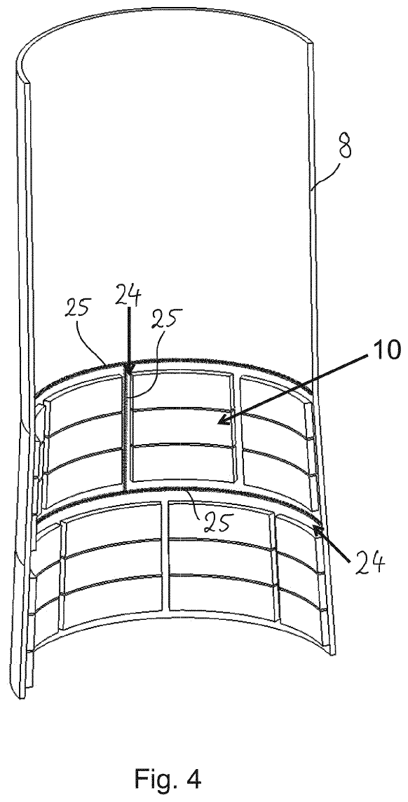

In the arrangement of the connection apparatus 10 as disclosed in FIG. 4 between the two components 6, 8 of the structure, some of the connection elements 12 are arranged in the direction of the longitudinal axis 14 close together one above the other so that an almost complete coverage of individual regions is produced. However, there extend between these regions faces which are not covered by the connection elements 12 so that weld seams 25 which are provided on the transition piece (component 8) can be arranged in the gaps 24 which have been produced. The stress on the weld seams 25 is thereby reduced in the completely assembled state of the tower-like structure. As an alternative to the arrangement of the connection elements 12 with spacing from each other, in the connection elements 12 at locations where they would cover the weld seams 25, recesses can be introduced without completely penetrating through the material of the connection elements 12. The weld seams 25 would consequently be recessed in the connection elements 12 or positioned in the corresponding recesses of the connection elements 12.

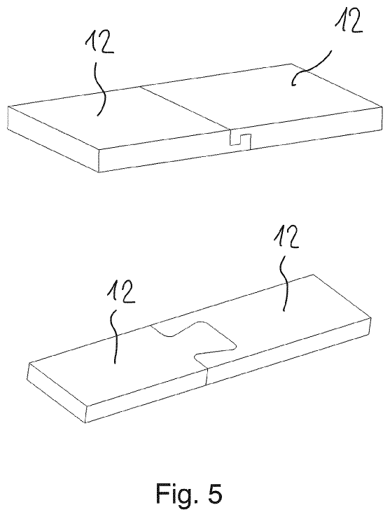

According to the further developments shown in FIG. 5, connection elements 12 can be arranged by means of securing regions which are constructed in a mutually complementary manner in particular in a positive-locking manner one on the other. In the lower portion of FIG. 5, the connection elements are connected in the manner of puzzle pieces, whilst the connection elements 12 are connected according to the upper illustration of FIG. 5 in the manner of a scarf joint.

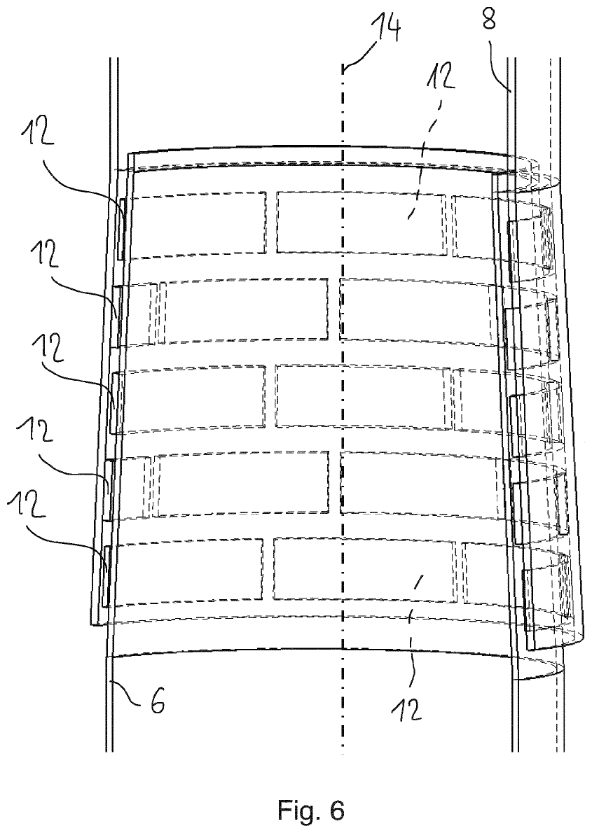

A structure according to the invention according to FIG. 6 is provided with connection elements 12 which comprises in a circumferential direction around the longitudinal axis 14 circular rings which are constructed from the connection elements 12, wherein the lowest ring has a thickness of 3.1 cm, the three central rings have a thickness of 3.4 cm and the uppermost ring has a thickness of 3.1 cm again so that the main load transfer is carried out via the three central connection elements.

1. A connection apparatus for a tower-like structure, the tower-like structure including an upper component and a lower component, the connection apparatus comprising:
a plurality of connection elements which:
in order to produce a slip joint, are arranged between the upper component and the lower component of the tower-like structure, and
for the purpose of the load transfer between the upper component of the tower-like structure and the lower component of the tower-like structure are positioned beside each other in a circumferential direction about the longitudinal axis and/or in a longitudinal direction thereof with respect to a longitudinal center axis of the tower-like structure;
wherein, with respect to the longitudinal axis the connection apparatus centrally has a greater thickness than at the upper and/or lower end thereof,
wherein connection element which is positioned in a longitudinal direction between an upper and a lower connection element has a greater thickness than the upper and/or the lower connection element.

2. The connection apparatus as claimed in claim 1, wherein a plurality of central connection elements which are arranged beside each other between an upper and a lower connection element in a longitudinal direction have a greater thickness than the upper and/or the lower connection element.

3. The connection apparatus as claimed in claim 1, wherein from connection elements which are arranged beside each other in a circumferential direction, one has a greater thickness than the connection elements which are arranged beside it.

4. The connection apparatus as claimed in claim 1, wherein at least some of the connection elements are at least partially resiliently deformable.

5. The connection apparatus as claimed in claim 1, wherein at least some of the connection elements are at least partially compressible.

6. The connection apparatus as claimed in claim 4, wherein the connection elements are at least also made from polyurethane.

7. The connection apparatus as claimed in 6, wherein the connection elements are constructed with at least two layers and have at least one layer of a polyurethane.

8. The connection apparatus as claimed in claim 7, wherein at least some of the connection elements, in addition to the layer of polyurethane, has at least one friction-reducing coating.

9. The connection apparatus as claimed in claim 1, wherein at least some of the connection elements have a thickness which decreases in the longitudinal direction.

10. The connection apparatus as claimed in claim 1, wherein at least some of the connection elements are at least partially provided with an adhesive layer.

11. The connection apparatus as claimed in claim 1, wherein at least two of the connection elements have mutually complementary connection regions.

12. The connection apparatus as claimed in claim 1, wherein a connection element has at least one recess in order to receive a portion of a component.

13. A tower-like structure of a wind turbine, the tower-like structure comprising:
at least one lower component and
at least one upper component which in order to form a slip joint is placed partially over the lower component,
wherein between the upper component and the lower component a connection apparatus as claimed in claim 1 is arranged,
wherein a support which extends at least in a circumferential direction is arranged below a or the lowest connection element.

14. The method for producing a tower-like structure as claimed in claim 13, wherein at least some of the connection elements are injection-molded or cast on the lower component and/or the upper component.

15. The method for producing a tower-like structure as claimed in claim 13, wherein at least some of the connection elements are produced beforehand and subsequently secured to the lower component and/or upper component.

16. The method as claimed in claim 15, wherein the upper component and/or the lower component is/are measured after the production thereof, and a deviation measurement which results from a deviation from a desired shape is taken into consideration by different thickness and/or planar extent of the connection elements.

17. The method as claimed in claim 16, wherein the deviation measurement is taken into consideration by re-processing at least one of the connection elements.

18. The connection apparatus as claimed in claim 1, wherein the plurality of connection elements are plate-like or layer-like.

19. The connection apparatus as claimed in claim 5, wherein the compressibility of the respective connection element is formed by a structuring of the surface and/or the material of at least one layer of the multi-layered connection element.

20. The connection apparatus as claimed in claim 11, wherein the at least two of the connection elements have positive-locking connection regions.

21. The connection apparatus as claimed in claim 12, wherein the at least one recess is introduced after the production connection element, and wherein the at least one recess receives a portion of a component in such a manner that a central or upper connection element has a varying thickness.

22. The connection apparatus as claimed in claim 13, wherein the at least one lower component is a monopile and the at least one upper component is a transition piece.
